(19) United States
(12) Patent Application Publication
(10) Pub. No.: US 2007/0252317 A1
(43) Pub. Date: Nov. 1, 2007

(54) ANTI-VIBRATION PADS FOR FRONT LOADING APPLIANCES

(75) Inventors: Kenneth Boehnlein, Ravenna, OH (US); Brenda Novak, Macedonia, OH (US)

Correspondence Address: FAY SHARPE LLP, 1100 SUPERIOR AVENUE, SEVENTH FLOOR, CLEVELAND, OH, 44114, US

(73) Assignee: GVI Enterprises, Inc., Ravenna, OH (US)

(21) Appl. No.: 11/742,101

(22) Filed: Apr. 30, 2007

Related U.S. Application Data
(60) Provisional application No. 60/795,740, filed on Apr. 28, 2006.

(51) Int. Cl. F16F 1/36

(52) U.S. Cl. 267/153; 267/152

(57) ABSTRACT

An anti-vibration pad comprises a rubber cylinder having a recess for a foot of a front loading appliance and having a specific hardness. The pad isolates and/or reduces the vibration of the appliance to prevent movement of the appliance and to increase end user satisfaction.

This application claims priority to U.S. Provisional Application Ser. No. 60/795,740, filed Apr. 28, 2006, which is fully incorporated by reference herein.

### BACKGROUND

The present disclosure is directed to a system, a process, and a composition for reducing or dampening vibration in front loading appliances, such as front loading washers and dryers.

Front loading appliances, such as clothes washers and dryers, rotate vertically at high speeds, generally over 1000 RPMs. When these machines are utilized with a joist/rafter-based flooring system, such as on the first or second floor of a residential home, it has been found that these appliances shake and/or vibrate extensively. This causes loud noise and in some cases, the appliance can “walk” around.

It would be desirable to provide a system to reduce the vibration of a front loading appliance. This would provide a more pleasing atmosphere and reduce complaints from end users.

### BRIEF DESCRIPTION

The present disclosure provides pads which can be used to reduce or dampen the transfer of vibration from a front loading appliance to the floor. Such pads may isolate and/or absorb the vibration.

In embodiments, the pad comprises a rubber cylinder having a top surface and a bottom surface; the top surface having a circular recess at its center; and the rubber cylinder having a Shore A hardness of from about 70 to about 95.

In other embodiments, a solid rubber cylinder has a top surface and a bottom surface; the rubber cylinder having a height of about 1.25 inches and a diameter of about 3.4 inches; the top surface having a circular recess at its center, the recess having a depth of about 0.25 inches and a diameter of about 2 inches; the rubber cylinder having a Shore A hardness of from 80 to 90; and the rubber cylinder weighing from at least 8.5 ounces to about 10.5 ounces.

In other embodiments, a system for reducing the vibration of a front loading appliance comprises a plurality of pads, wherein each pad comprises: a rubber cylinder having a top surface and a bottom surface; the top surface having a circular recess at its center; and the rubber cylinder having a Shore A hardness of from about 70 to about 95.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a top view of a pad of the present disclosure.

FIG. 2 is a perspective view of a pad of the present disclosure.

### DETAILED DESCRIPTION

A more complete understanding of the anti-vibration pad can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the present disclosure. In particular, some components are defined in relative terms, e.g. “top,” “bottom,” etc. These relative terms are used for ease of description and should not be construed as limiting the components.

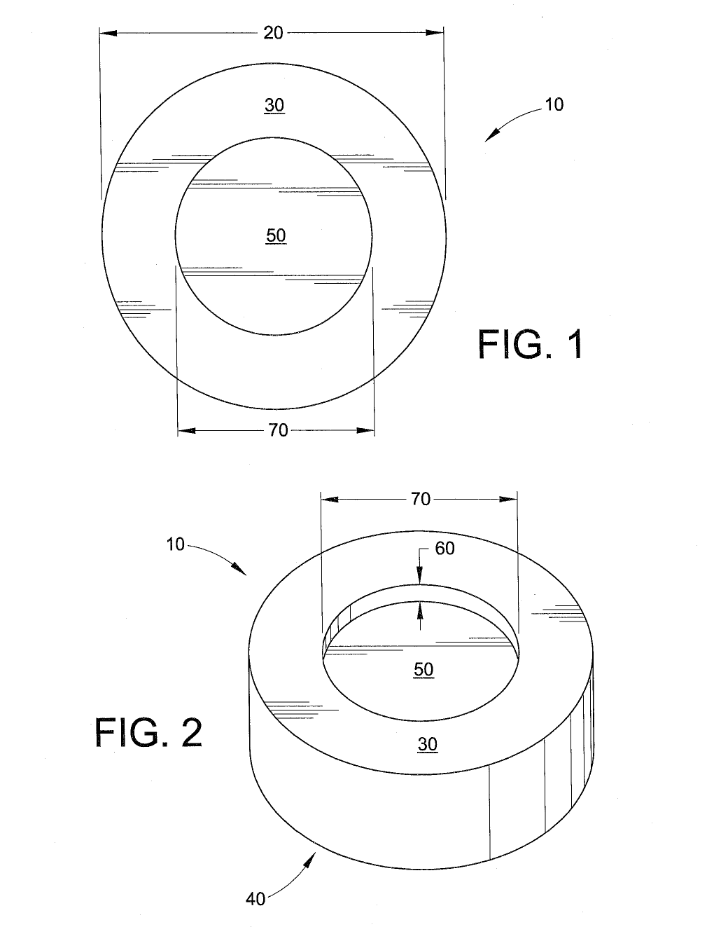

Referring to FIGS. 1 and 2, the pad 10 is a cylinder and appears circular in this view. The pad 10 has a diameter 20. In embodiments, the diameter is from about 3.25 to about 3.5 inches. In specific embodiments, the diameter is about three and three-eighths inches; rounded to one decimal place, the diameter is about 3.4 inches. The cylinder has a top surface 30 and a bottom surface 40. A recess 50 is located in the center of the top surface 30 for placing a foot of the front loading appliance. The recess 50 has a depth 60 and a diameter 70. In embodiments, the recess depth 60 is from about 0.2 to about 0.5 inches. In specific embodiments, the recess depth 60 is about one-quarter inch, or about 0.25 inches. In embodiments, the recess diameter 70 is from about 1.75 to about 2.25 inches. In specific embodiments, the recess diameter 70 is about 2.0 inches.

The pad 10 is generally solid. For example, besides the recess 50 which aids in placing the pad 10 with relation to a foot of the front loading machine, the body of the pad 10 generally contains no other grooves, vents, or voids. Without being bound by theory, it appears that such grooves, vents, and voids reduce the effectiveness of the pad 10 in dampening vibrations. Alternatively, such grooves, vents, and voids may lighten the pad 10 below a certain necessary range. In some particular embodiments, the pad 10 weighs at least 8.5 ounces. In embodiments, the pad weighs from at least 8.5 ounces to about 10.5 ounces.

The pad 10 is generally a neoprene rubber. In particular, it has been found that a pad made from urethane does not dampen vibration at all. The rubber which makes up the pad 10 needs to be stiff enough to dampen the vibration. In embodiments, the pad 10 has a Shore A hardness of from about 70 to about 95. In specific embodiments, the pad 10 has a Shore A hardness of from 80 to 90.

In further embodiments, the pad 10 further comprises an adhesive layer (not shown) which is attached to the bottom surface 40. This allows the pad 10 to be anchored to the floor and further reduce movement of the front loading appliance. During shipment, the adhesive layer is covered with a removable backing. Such an adhesive layer can be applied as a double-sided adhesive available, for example, from 3M.

The pad 10 may be any color and is generally a gray color. In particular, it was found that when the pad 10 was colored black by the use of carbon black, the pad 10 would leave black marks on the floor over time.

In further embodiments, an anti-vibration system for reducing the vibration of a front loading appliance is provided. The system comprises a plurality of pads as described above. In particular, the system comprises a total of two or four pads.

The following Examples further define and describe embodiments of the present disclosure, but do not limit it.

### EXAMPLES

All examples were performed using a front loading clothes washer manufactured by LG, model number WM2277HW. Tests were conducted on a wood floor supported by 2×6 wood joists and in some cases, with 12×12 inch ceramic tile over the floor.

### Control

The washer was placed on the floor and leveled without any rubber mats. During the spin cycle, the washer vibrated heavily and started walking across the floor. The vibrations also caused a pepper shaker on a stove 12 feet away to fall over.

### Thickness Testing

The washer was placed on a rubber mat one-quarter inch thick and leveled. To test the amount of vibration, a vase of flowers was placed on a table next to the washer and a string was attached to a joist supporting the floor under the washer. During the spin cycle, the vibration was reduced, but the flowers on the table vibrated and vibration could be felt in the string.

Next, the washer was placed on a rubber mat one-half inch thick and leveled. Again, the vibration was reduced, but not eliminated.

Next, the washer was placed on the ceramic tile using the one-quarter inch rubber mat and leveled. Again, the vibration was reduced, but not eliminated.

Next, the washer was placed on the ceramic tile using both the one-quarter inch and the one-half inch mats (for a total thickness of three-quarters inches) and leveled. This reduced the vibration significantly. The flowers on the table and the string only vibrated slightly.

Next, the washer was placed on the ceramic tile atop rubber mats having a total thickness of one inch. This also reduced the vibration significantly. The flowers on the table and the string did not vibrate, but a slight vibration could still be felt on the floor when standing next to the washer.

The data showed that the thickness of the rubber contributed to reducing the transfer of vibration from the washer.

In further testing, a vibration meter was used to measure the velocity and displacement of vibration. The probe was attached to the floor in front of the washer. Nine towels, weighing approximately 11 pounds, were used in each test load. Each test cycle consisted of a complete wash cycle. The measurements were recorded during the spin cycle at 7 and 22 minutes, when the vibration appeared to be strongest. Of course, the entire spin cycle lasted longer. Generally, each pad was tested for a minimum of 20 spin cycles

### Example 1

Example 1 was a square pad made from two layers of masticated rubber. The square pad measured approximately 2.75 inches on each side and had a total height of about 0.75 inches.

### Example 2

Example 2 was a square pad made from two layers of masticated rubber. The square pad measured approximately 2.75 inches on each side and had a total height of about five-eighths inch.

### Example 3

Example 3 was a square pad made from three layers of masticated rubber. The square pad measured approximately 2.75 inches on each side and had a total height of about fifteen-sixteenths inch.

### Example 4

Example 4 was a square pad measuring approximately 2.75 inches on each side. The bottom layer was masticated rubber having a height of about three-eighths inch. Upon this bottom layer was an aluminum plate having a height of about one-eighths inch. On top of the aluminum plate were two layers of masticated rubber having a total height of about one-half inch. The total height of the pad, including all layers, was about one inch. A circular recess was included on the top; the recess was about 1.75 inches in diameter and about one-quarter inch in depth.

### Example 5

Example 5 was a square pad measuring approximately 3 inches on each side. The bottom layer was masticated rubber having a height of about three-eighths inch. Upon this bottom layer was an aluminum plate having a height of about one-sixteenth inch. On top of the aluminum plate were two layers of masticated rubber having a total height of about five-eighths inch. The total height of the pad, including all layers, was about one inch. A circular recess was included on the top; the recess was about 1.75 inches in diameter and about one-quarter inch in depth.

### Example 6

Example 6 was a black cylindrical pad approximately 1 and one-eighths inch tall and having a diameter of about 3 and three-eighths inches. The pad was made from mixed neoprene. On the top surface was a circular recess having a diameter of about 2 and one-eighths inches and a depth of about one-eighth inch. The pad had a durometer reading of between 70 and 80 and weighed about 8.5 ounces.

### Example 7

Example 7 was a black cylindrical pad approximately 1.5 inches tall and having a diameter of about 3 and three-eighths inches. The pad was made from a urethane. On the top surface was a circular recess having a diameter of about 1 and five-eighths inches and a depth of about one-quarter inch. The pad had a durometer reading of between 80 and 90 and weighed about 8.5 ounces. As discussed later, this pad was only tested for one spin cycle because it did not work at all.

### Example 8

Example 8 was a clear green cylindrical pad approximately 1.5 inches tall and having a diameter of about 3 and three-eighths inches. The pad was made from a urethane. On the top surface was a circular recess having a diameter of about 1 and five-eighths inches and a depth of about one-quarter inch. The pad had a durometer reading of between 50 and 60 and weighed about 8.5 ounces. As discussed later, this pad was only tested for one spin cycle because it did not work at all.

### Example 9

Example 9 was a black cylindrical pad approximately 1.25 inches tall and having a diameter of about 3 and one-quarter inches. The pad was made from an ethylene propylene diene monomer (EPDM) rubber. On the top surface was a circular recess having a diameter of about 1 and five-eighths inches and a depth of about one-quarter inch. The pad had a durometer reading of between 65 and 70 and weighed about 7 ounces. On the bottom surface, a circular recess was cut out of the center. This recess was about one-half inch in diameter and one-half inch in depth. In addition, two roughly annular grooves were made into the bottom surface. Each annular groove was about one-eighth inch wide and one-half inch in depth. The first annular groove began approximately seven-eighths inches away from the center and the second annular groove began approximately one and one-quarter inches away from the center. However, material was left in each annular groove every 90° that was about one-quarter inch wide to join the middle portion (between the two annular grooves) to the outer and inner portions. The recess and grooves in the bottom surface were designed to reduce the weight and amount of material used.

### Example 10

Example 10 was a gray cylindrical pad approximately 1.25 inches tall and having a diameter of about 3 and three-eighths inches. The pad was made from an EPDM rubber. On the top surface was a circular recess having a diameter of about 1 and five-eighths inches and a depth of about one-quarter inch. The pad had a durometer reading of between 65 and 70 and weighed about 8 ounces. On the bottom surface, a circular recess was cut out of the center. This recess was about one-half inch in diameter and one-half inch in depth. In addition, two roughly annular grooves were made into the bottom surface. Each annular groove was about one-eighth inch wide and one-half inch in depth. The first annular groove began approximately seven-eighths inches away from the center and the second annular groove began approximately one and one-quarter inches away from the center. However, material was left in each annular groove every 90° that was about one-quarter inch wide to join the middle portion (between the two annular grooves) to the outer and inner portions. The recess and grooves in the bottom surface were designed to reduce the weight and amount of material used.

### Example 11

Example 11 was a gray cylindrical pad approximately 1 and one-eighths inches tall and having a diameter of about 3 and three-eighths inches. The pad was made from neoprene. On the top surface was a circular recess having a diameter of about 1 and five-eighths inches and a depth of about one-quarter inch. The pad had a durometer reading of between 80 and 90 and weighed about 8.75 ounces.

### Example 12

Example 12 was a gray cylindrical pad approximately 1.25 inches tall and having a diameter of about 3 and three-eighths inches. The pad was made from neoprene. On the top surface was a circular recess having a diameter of about 1 and five-eighths inches and a depth of about one-quarter inch. The pad had a durometer reading of between 80 and 90 and weighed about 10.5 ounces.

### Example 13

Example 13 was a gray cylindrical pad approximately 1.25 inches tall and having a diameter of about 3 and three-eighths inches. The pad was made from neoprene. On the top surface was a circular recess having a diameter of about 1 and fifteen-sixteenths inches and a depth of about one-quarter inch.

### Example 14

Example 14 was a gray cylindrical pad approximately 1.25 inches tall and having a diameter of about 3 and three-eighths inches. The pad was made from neoprene. On the top surface was a circular recess having a diameter of about 1 and fifteen-sixteenths inches and a depth of about one-quarter inch. On the bottom surface was an adhesive layer

### Results

As discussed above, each pad was tested at least 20 times (except Examples 7 and 8), and the displacement and velocity of vibration was measured at 7 minutes and at 22 minutes. Table 1 shows the results. For each measurement, the highest and lowest values are shown.

TABLE 1

| | Spin Cycle | | | | | | | |
|---|---|---|---|---|---|---|---|---|
| | 7 minutes | | | | 22 minutes | | | |
| Example | Low D | High D | Low V | High V | Low D | High D | Low V | High V |
| Control | 1.6 | 2.4 | 2 | 2.5 | 1.7 | 1.9 | 1.9 | 2.1 |
| 1 | 1.4 | 1.7 | 1.4 | 1.7 | 1.3 | 1.5 | 1.5 | 1.7 |
| 2 | 1.3 | 1.5 | 1.5 | 1.7 | 1.3 | 1.5 | 1.3 | 1.6 |
| 3 | 0.9 | 1.2 | 1.1 | 1.4 | 1.1 | 1.3 | 1.0 | 1.2 |
| 4 | 1.0 | 1.3 | 1.2 | 1.5 | 1.1 | 1.3 | 1.0 | 1.3 |
| 5 | 1.2 | 1.4 | 1.2 | 1.4 | 1.2 | 1.4 | 1.1 | 1.3 |
| 6 | 0.8 | 0.9 | 0.9 | 1.1 | 0.6 | 0.9 | 0.8 | 1.2 |
| 7 | N/A | N/A | N/A | N/A | N/A | 1.8 | N/A | 2 |
| 8 | N/A | N/A | N/A | N/A | N/A | 1.8 | N/A | 2.1 |
| 9 | 1.1 | 1.4 | 1.1 | 1.3 | 1.1 | 1.4 | 1.3 | 1.6 |
| 10 | 1.2 | 1.4 | 1.1 | 1.3 | 1.2 | 1.4 | 1.3 | 1.6 |
| 11 | 0.8 | 1.1 | 0.9 | 1.2 | 0.9 | 1.3 | 1.1 | 1.3 |
| 12 | 0.5 | 0.7 | 0.7 | 0.9 | 0.5 | 0.8 | 0.6 | 0.9 |
| 13 | 0.6 | 0.7 | 0.8 | 1.0 | 0.5 | 0.8 | 0.6 | 0.9 |
| 14 | 0.6 | 0.7 | 0.7 | 0.9 | 0.4 | 0.6 | 0.6 | 0.8 |

As can be seen from Table 1, the pads of Examples 12-14 generally performed best across all columns, followed by the pad of Example 6.

The pads of Examples 7 and 8 performed particularly poorly. They allowed the washer to vibrate, shake, and walk. Although they had the same size as that of Examples 12-14 and Example 7 also had the same durometer readings, Examples 7 and 8 were made from urethane instead of neoprene. Neoprene performed better.

The pads of Examples 9 and 10 had material removed from the bottom surface. However, this construction did not improve the anti-vibration properties of the pads.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A pad for reducing vibration, comprising a rubber cylinder having a top surface and a bottom surface;
the top surface having a circular recess at its center; and
the rubber cylinder having a Shore A hardness of from about 70 to about 95.

2. The pad of claim 1, wherein the rubber cylinder comprises neoprene rubber.

3. The pad of claim 1, wherein the rubber cylinder has a Shore A hardness from 80 to 90.

4. The pad of claim 1, wherein the rubber cylinder has a height of about 1.25 inches.

5. The pad of claim 1, wherein the rubber cylinder has a diameter of about 3.4 inches.

6. The pad of claim 1, wherein the circular recess has a diameter of about 2 inches.

7. The pad of claim 1, wherein the circular recess has a depth of about 0.25 inches.

8. The pad of claim 1, wherein the rubber cylinder is solid.

9. The pad of claim 1, wherein the pad weighs at least 8.5 ounces.

10. The pad of claim 1, wherein the pad weighs from at least 8.5 ounces to about 10.5 ounces.

11. The pad of claim 1, further comprising an adhesive layer on the bottom surface.

12. A solid rubber cylinder having a top surface and a bottom surface;
the rubber cylinder having a height of about 1.25 inches and a diameter of about 3.4 inches;
the top surface having a circular recess at its center, the recess having a depth of about 0.25 inches and a diameter of about 2 inches; and
the rubber cylinder having a Shore A hardness of from 80 to 90.

13. The rubber cylinder of claim 12, wherein the rubber cylinder weighs from at least 8.5 ounces to about 10.5 ounces.

14. The rubber cylinder of claim 12, wherein the rubber cylinder is made from neoprene rubber.

15. The rubber cylinder of claim 12, further comprising an adhesive layer on the bottom surface.

16. A system for reducing the vibration of a front loading appliance, comprising a plurality of pads, wherein each pad comprises:
a rubber cylinder having a top surface and a bottom surface;
the top surface having a circular recess at its center; and
the rubber cylinder having a Shore A hardness of from about 70 to about 95.

17. The system of claim 16, wherein the system has a total of two pads.

18. The system of claim 16, wherein the system has a total of four pads.

19. The system of claim 16, wherein the rubber cylinder has a height of about 1.25 inches and a diameter of about 3.4 inches;
the top surface has a circular recess at its center, the recess having a depth of about 0.25 inches and a diameter of about 2 inches; and
the rubber cylinder weighs from at least 8.5 ounces to about 10.5 ounces.

20. The system of claim 16, wherein the rubber cylinder further comprises an adhesive layer on the bottom surface.
